(19) United States
(12) Patent Application Publication
(10) Pub. No.: US 2018/0161238 A1
(43) Pub. Date: Jun. 14, 2018

(54) APPARATUS AND METHOD FOR ASSISTING A USER DURING A CARDIOPULMONARY RESUSCITATION

(71) Applicants: Donald Herbert DUSSAULT, Stockach (DE); Dominic Oliver DUSSAULT, Stockach (DE)

(72) Inventors: Donald Herbert DUSSAULT, Stockach (DE); Dominic Oliver DUSSAULT, Stockach (DE)

(21) Appl. No.: 15/577,004

(22) PCT Filed: May 23, 2016
(86) PCT No.: PCT/EP2016/000851

§ 371 Date: Nov. 27, 2017

(30) Foreign Application Priority Data
May 27, 2015 (DE) 10 2015 006 540.8

(51) Int. Cl. A61H 31/00

(52) U.S. Cl. CPC A61H 31/005; A61H 31/006; A61H 2201/5097; A61H 2201/5043; A61H 2031/002

(57) ABSTRACT

Apparatus (1, 50) according to the invention for assisting a user during cardiopulmonary resuscitation of a patient (40), which comprises a force transmission unit (10) with a lower plate (11) that can be placed on the patient's chest (40), an upper plate (12) located at a distance from the lower plate (11), and a force sensor (13) arranged between the lower plate (11) and the upper plate (12) for detecting a force that can be exerted on the patient's chest (40) by means of the upper plate (12) and the lower plate (11), an indicator device for generating at least one signal that can be perceived by the user, and an electronic control device for controlling the indicator device based on the force detected by the force sensor, wherein the force transmission unit (10) is embedded in a flexible mat (2).

The present invention concerns an apparatus and a method for assisting a user during cardiopulmonary resuscitation.

When a person suffers cardiac arrest, cardiopulmonary resuscitation must be initiated immediately whenever possible. In this process, cardiac massage, in which a compressive force is exerted on the center of the patient's chest at a rate of approximately 100 to 120 times a minute, is of primary importance. This force presses the sternum down so that blood is forced out of the heart into the circulation. In the relaxation phases between compressions, the heart again fills with blood. Whenever possible, cardiac massage should be supplemented with ventilation.

In particular, in accidents and other emergency situations, there are often no medically trained personnel present. The performance of cardiopulmonary resuscitation, particularly cardiac massage, by a lay person is then decisive for the survival of the patient. Because of a lack of training and/or practice, however, lay persons are often incapable of correctly performing cardiopulmonary resuscitation. In particular, there is often uncertainty, for example regarding the point at which the compressive force must be exerted, the amount of compressive force to be exerted, how long the relaxation period between two compressions should be, and/or the frequency of the compressions. This uncertainty may be increased by the situation in which cardiac arrest occurs, for example in a traffic accident. Devices for assisting a user, specifically a medical lay person, during cardiopulmonary resuscitation have therefore been developed.

U.S. Pat. No. 5,496,257 describes a portable apparatus for assisting a rescuer in administering cardiopulmonary resuscitation on a patient having a housing that rests on the patient's chest so that compressive forces can be applied to the patient's chest by means of the apparatus. The apparatus has an on/off switch and visual and acoustic indicators. Moreover, a processor unit is provided that compares allowable values stored in a ROM chip with currently measured values and activates the indicators in order to help the rescuer correctly perform cardiopulmonary resuscitation.

WO 2004/056303 A1 discloses a device for use in chest compression in connection with cardiopulmonary resuscitation that is configured to emit a sound when the chest compression is performed with a force that exceeds a predetermined value and also emit a sound that indicates the desirable frequency of chest compression. After the device is placed in the correct position on the patient's chest, the user manually exerts pressure on the upper surface of the device. This causes a peg connected to an upper part of the device to be pressed against a contact connected to a lower part of the device, thus closing a power supply circuit of a microcontroller circuit. This activates an electronic metronome that emits a sound at a predetermined rate. A mechanical sound generator emits a click each time the user compresses the device. By comparing the mechanically emitted click with the sound produced by the metronome, the user can determine whether he/she is exerting the compressive force with the necessary strength and frequency. An electronic sound generator can be provided instead of the mechanical sound generator.

WO 2014/071915 A2 discloses a device for controlled cardiopulmonary resuscitation during cardiac arrest that is composed of a curved pressure transmission means connected at its ends to a flat, relatively rigid pressure-receiving element. The geometric dimensions of the device are approx. 10 to 25 cm in diameter and approx. 6 to 12 cm in height. In application, a mechanical pressure is exerted on the pressure transmission means, which generates a perceptible signal when a maximum exertion of force is reached, said signal resulting from the interaction of spring elements. In one embodiment, strain gauges can be arranged at the end of the pressure transmission means that send a signal to an electronic device, causing a perceptible acoustic or optical signal to be generated.

US 2011/0201979 A1 describes a system for cardiopulmonary resuscitation by guided active compression-decompression that is attached to the chest of a patient using an adhesive pad in order to exert compressive and decompressive forces. The system comprises a handle with a stem that contains a load cell for measuring the compressive and decompressive forces. In one embodiment for manual use, the system comprises a mushroom-shaped element with a handle that is attached to the upper surface of a flexible contact pad by means of a stem. The contact pad has an adhesive for fixing the contact pad on a surface of the patient's chest. In use, the device is placed approximately in the middle of the sternum on the patient's chest, and the user grasps the handle with both hands and exerts compressive force on it; after the compression stroke is completed, the user lifts up the handle to expand the chest.

U.S. Pat. No. 4,355,634 discloses a locator device for cardiac compression during cardiopulmonary resuscitation. The device comprises a rectangular elongated main body of unyielding foam plastic and top and bottom cushion-like foam layers attached thereto. A palpable tactile signalling device, which emits a signal when a predetermined compressive force is exerted, is arranged in a rectangular opening in the main body.

According to DE 202007009575 U1, a device for compressing a human or animal body comprises means for guiding the user in compression that emit a sound when the chest has been compressed to the correct depth. The device can be configured as a cushion or a bag.

The non-generic publication US 2007/0053504 A1 discloses a connection device of a flip-open cellular telephone which has a connecting section that rotatably connects two housing sections to each other.

An object of the present invention is to provide an improved device for assisting a user during cardiopulmonary resuscitation, in particular a device of the generic type which is improved with respect to production costs, simplicity and safety of use, and/or storage and transport capability. An object of the invention is also to provide an improved method for assisting a user during cardiopulmonary resuscitation.

This object is achieved by an apparatus according to claim 1 and by a method according to claim 15. Advantageous improvements of the invention are given in the subordinate claims.

An apparatus according to the invention is configured for assisting a user during cardiopulmonary resuscitation of a patient. “User” is understood here to refer to a person who administers cardiopulmonary resuscitation, without this implying any limitation on the persons in question. In particular, the user can be a medical lay person, but can also be a medically trained person, for example a trained first responder. Several persons may also perform the cardiopulmonary resuscitation, for example with multiple persons alternately or simultaneously carrying out cardiac massage and/or one or more other persons carrying out ventilation; in this case, the multiple persons carrying out the resuscitation will also be referred to as “the user.” The term “patient” used in the following refers to the person on whom cardiopulmonary resuscitation is performed, regardless of the cause and circumstances of the resuscitation. Use of the apparatus according to the invention will be described in the following with respect to a person, but it is understood that the apparatus can also be used on a manikin for training purposes.

The apparatus according to the invention comprises a force transmission unit, which is configured for transmission and detection of a force that can be exerted by a user during cardiac massage on the patient's chest. This force, which is exerted in a direction essentially perpendicular to the surface of the chest and is transmitted via the force transmission unit to the chest, is also referred to in the following as “pressing force” or “compressive force.” The apparatus is preferably configured only for exerting a compressive force on the chest and not for exerting a pulling force. The force transmission unit comprises a lower plate that can be placed on the patient's chest, which is preferably configured as an essentially flat, rounded disk. Here and in the following, the “underside” refers to the side facing the patient, and the “upper side” refers to the side facing the user. In particular, the lower plate may be a flat, circular disk having a diameter of approximately 5 to 12 cm. This size approximately corresponds to the size of the surface of the chest to which pressure is to be applied during cardiac massage. For example, the lower plate can be configured as a thin disk having a thickness of approximately 1 mm.

The force transmission device further comprises an upper plate that is arranged at a distance from the lower plate, in particular parallel thereto and largely congruent therewith, so that the upper and the lower plate essentially overlap each other. The upper plate is preferably configured identically to the lower plate, i.e. specifically as a thin circular disk with a diameter of approx. 5 to 12 cm and a thickness of approx. 1 mm. For example, the lower and the upper plate may be composed of a hard plastic.

A force sensor for detecting a force applied by means of the upper plate to the lower plate is arranged between the lower and the upper plate. For this purpose, the force sensor can in particular be adjacent to the lower and the upper plate and thus support the upper plate on the lower plate and transmit forces from the upper to the lower plate while simultaneously detecting said forces. If a compressive force is exerted on the upper plate perpendicularly to the surface of the plate, said force, when the lower plate rests directly or indirectly on the surface of the chest, is transmitted from the upper to the lower plate and further to the chest, and is simultaneously detected by the force sensor. In particular, the force sensor can emit an analog or digital sensor signal that represents the force detected by the force sensor and thus allows a conclusion to be drawn regarding the compressive force exerted by the user on the upper plate and transmitted by the force transmission unit to the patient's chest.

The apparatus according to the invention further comprises an indicator device configured for generating at least one signal that can be perceived by the user. In particular, the signal can be an acoustic, optical and/or haptic signal. Specifically, the type and intensity of the signal are such that it can be perceived under a wide variety of environmental conditions. More particularly, an optical signal is bright enough or an acoustic signal is loud enough to be reliably perceived by a user in every case at an accident site with widely differing bright illumination and e.g. loud traffic noises. Particularly preferably, the indicator device can be configured to generate signals that can be perceived via different sensory channels, for example for synchronous generation of an acoustic and an optical signal. Such redundant signals can make it possible for at least one signal to be perceptible with increased reliability under widely varying environmental conditions.

The apparatus according to the invention further comprises an electronic control device that is configured for controlling the indicator device based on the force detected by the force sensor or the sensor signal emitted by the force sensor. For this purpose, the electronic control device is connected to the indicator device and the force sensor, in particular via corresponding electrical wires. The electronic control device can comprise a microcontroller or a microprocessor, and can be configured for further evaluation of the sensor signal picked up from the force sensor, for example by comparison with predetermined target values.

According to the invention, the force transmission unit is embedded in a mat. The mat is configured to be flexible, i.e. bendable in at least one direction, and it is preferably slack. In particular, the flexible mat is configured in sheetlike form and has a larger surface than the force transmission unit, and in particular has an expansion many times greater than that of the force transmission unit. The mat should preferably extend beyond the force transmission unit on all sides. For example, the mat may be rectangular, rectangular with rounded corners, or configured in another form. The force transmission unit can be embedded approximately in the middle of the surface of the mat. In particular, the force transmission unit can be glued onto the mat. The force transmission unit is preferably completely enclosed by the mat, i.e. covered in particular both on the underside of the lower plate and the upper side of the upper plate by the material of the mat and also laterally enclosed by the mat; the flexible mat can thus be used to protect the force transmission unit from moisture or soiling. The flexible mat can serve as a mechanical carrier in order to improve handling of the force transmission unit. The flexible mat can further be used for more even distribution of the compressive force exerted by the force transmission unit over the patient's chest and for preventing any edges of the force transmission unit from injuring the patient. For example, the mat can also be configured as a pad or cushion or comprise such a pad or cushion. The control device and the indicator device can thus be completely or partially embedded in the flexible mat.

Because the force transmission unit is embedded in a flexible mat that extends beyond the surface of the force transmission unit, the apparatus according to the invention can be more easily and reliably placed on the chest of the patient on whom cardiac massage is to be carried out. In particular, this allows the apparatus to be more reliably placed, so that the force transmission unit rests more stably on the area of the surface of the chest to which pressure is to be applied in cardiac massage. In particular, the form of the mat can be adapted to physical characteristics, e.g. it can have a marking or an indentation for the patient's neck so that the mat can be aligned with the patient's neck and correct placement of the force transmission unit is facilitated. This improves the safety of use of the apparatus to assist cardiopulmonary resuscitation, in particular cardiac massage, even when this is carried out by a medical lay person. The flexibility of the mat allows it to be adapted to various physiological characteristics so that the apparatus according to the invention can be correctly placed on the chest regardless of the height, weight, and sex of the patient. As the mat is flexible, this also allows adaptation to various storage and transportation containers. Because the force transmission unit, and optionally the control and/or indicator device, is embedded in the flexible mat, which can be water-tight, it becomes simple to configure the apparatus as a whole to be water-tight, so that the apparatus is functional under virtually any environmental conditions. Finally, the mechanical complexity and spatial requirement of the apparatus can be reduced, reliability can be increased, and storage and transportation of the apparatus can be facilitated if at least one perceptible signal is generated on activation of the indicator device by the electronic control device and preferably no mechanical sound generation takes place.

Preferably, at least the lower plate is deformable for adaptation to the surface of the patient's chest, i.e. on application of the force required for the cardiac massage, the lower plate conforms to the shape of the surface of the chest such that the exerted force is distributed over a suitable area of compression of the chest, for example over a circular surface essentially arranged symmetrically to the sternum with a diameter of approximately 7 to 12 cm on the front side of the sternum. As the surface of the chest in the area of the sternum at which the compressive force for carrying out cardiac massage is to be exerted can be shaped differently depending on the patient, for example approximately level or curved inward, deformability of at least the lower plate allows more favorable distribution of the exerted force over the surface of the chest. Particularly preferably, the upper plate is also deformably configured in a similar manner, as well as the force sensor in the case of a flat configuration of said force sensor interposed between the lower and the upper plate. In particular, the force transmission unit is configured to be deformable as a whole with a stiffness greater than that of the flexible mat. The lower plate or the force transmission unit as a whole should preferably be configured in an elastically deformable manner. In particular, the stiffness of the to lower plate or of the force transmission unit can be specified such that when the latter is lying on a substrate with two edges opposite to each other, it yields in the middle relative to the edges by approximately one or more centimeters on exertion of a target force for the cardiac massage. For example, the lower and the upper plate can each be composed of a hard plastic. This can allow particularly simple distribution of the exerted force over a sufficient surface in virtually every case.

The flexible mat should preferably comprise at least two particularly flat layers between which the force transmission unit is embedded. The at least two layers are also configured to be flexible, and in particular are connected to one another in a planar manner. In a particularly advantageous configuration, the force transmission unit is embedded in the mat such that the underside of the lower plate is connected to the upper side of a lower layer and the upper side of the upper plate is connected to the underside of an upper layer of the mat. The at least two layers may be composed e.g. of rubber or a suitable foam. Because the mat comprises at least two preferably flat layers between which the force transmission unit is embedded, the apparatus according to the invention can be produced in a particularly simple manner. The indicator device and/or the control device can also be completely or partially embedded between the at least two preferably flat layers.

According to a preferred embodiment of the invention, the mat is configured to be slip-resistant on its underside and/or upper side and/or to be printable or printed on its upper side. For example, the underside of the mat can be configured with a slip-resistant coating and/or be roughened so that secure positioning on the patient's chest is ensured even when the mat is soiled, for example with sweat or blood. The upper side of the mat is also preferably provided with a slip-resistant coating and/or is roughened in order to allow secure placement of one or two hands of the user and ensure that the compressive force is securely exerted even if the upper side of the mat is soiled or wet. For example, instructions for performing cardiopulmonary resuscitation or cardiac massage may be printed on the upper side of the mat. Markings that make it easier to determine correct positioning of the force transmission unit and/or to achieve such positioning in patients of different body sizes can also be printed on the mat. For example, the mat may have different printed markings showing positioning thereof in children and adults. This facilitates use of the apparatus by medical lay persons and in stressful situations in particular.

In a further advantageous configuration, the apparatus can comprise a further flexible layer, which for example is composed of film or fabric and can be placed over the face of the patient when the apparatus is correctly positioned so as to provide facial protection or a protective mask for ventilation of the patient. For example, the further layer can be glued or reversibly attached by its edge to an edge area of the mat that rests on the upper area of the chest and may be placed over the patient's face. The further layer can have a form and/or markings that can provide additional assistance in aligning the apparatus on the patient's chest. This allows hygiene and safety during ventilation as a supplement to cardiac massage to be improved.

According to a preferred embodiment of the invention, the mat is configured to be foldable. For example, the mat as a whole can be flexible to a sufficient degree that a section of the mat can be placed by folding over another section. It is particularly preferred for the mat to have multiple, e.g. three sections connected to one another via predetermined fold lines. This can make it possible for the mat to be foldable, wherein the plurality of sections of the mat can be folded atop one other, lying flat in this state, and can then be correspondingly unfolded. Each of the sections of the mat can have a thickness that is essentially uniform but can optionally differ among the sections. In particular, the sections connected to one another via fold lines can themselves show higher stiffness, while the mat has lower stiffness at the fold lines and is bendable with a correspondingly smaller radius. The fold lines can e.g. be configured as fold grooves and can for example be produced by reducing the material strength of a mat that is otherwise configured with the same material strength throughout by stamping or milling in narrow linear areas of said mat; for example, the fold lines can also be configured as film hinges. A mat that is foldable in this manner will also be referred to as in the following as “foldable.” If the mat has three sections connected to one another that run essentially parallel to one another, these sections can be superposed so that two or three sections respectively lie on top of one another when the apparatus is closed. For example, the mat can be configured so as to be essentially rectangular and have two fold lines running parallel to each other and parallel to two opposite edges that divide the surface of the mat into three sections of approximately equal size; when the mat is then folded up, this gives rise to an arrangement in which each of the two lateral sections overlaps the middle section. The force transmission unit can be embedded in a section of the mat, and the control and/or indicator device can be embedded in one or a plurality of other sections. As the mat is configured to be foldable or have closeable flaps, storage, packaging, transportation, and carrying of the apparatus, e.g. in a motor vehicle, can be facilitated. In particular, in a configuration that is foldable or has closeable flaps, the mat can be dimensioned such that it has the format of a motor vehicle first aid kit according to DIN 13157 and fits into such a kit in this form; for application, the mat can be unfolded or opened in two simple working steps. An apparatus configured in this manner can easily be included in such a first aid kit so that it can be immediately and simply accessed in case of an accident.

It is also preferable for the control device to have a sleep mode and a working mode, wherein in sleep mode, the energy consumption of the control device is minimized and the force sensor and indicator device in particular are not operated, while in working mode, essentially all of the functions of the apparatus are activated. According to this embodiment of the invention, it is further provided that the apparatus comprises sensor means that generate signals based on which the control device is automatically switched from sleep mode to working mode when the mat is unfolded or opened. The sensor means may be configured e.g. as a magnetic sensor or a contact sensor. In particular, two interacting sensor elements can be arranged on two sections of the mat that are on top of each other when the mat is folded up; the sensor elements rest against each other when the mat is folded up, causing the sleep mode of the control device to be maintained, and are separated from each other when the mat is unfolded, causing the control device to be switched from sleep mode to working mode. This provides a simple and safe way to ensure that the apparatus according to the invention remains functional over a lengthy period, preferably for several years, and at the time of use is immediately ready for providing assistance during cardiopulmonary resuscitation without requiring any additional measures. Alternatively, the apparatus can have a switch which, when activated, turns on the control device or switches from sleep mode to working mode.

The control device is preferably configured such that the apparatus can be used only once. For this purpose, for example, one can set a time period during which, after the last exertion of a compressive force or after the control device is switched from sleep mode to working mode, no more compressive force has been exerted, and after a preset maximum duration of such inactivity is reached, the indicator device is permanently deactivated. The preset maximum duration of inactivity is thus selected such that one can be certain that an initiated resuscitation is ended, for example 15 minutes or one hour. This makes it possible with greater reliability to prevent an apparatus that has been used and is no longer fully functional, for example due to energy consumption, or no longer sufficiently meets hygiene requirements from being used again.

Alternatively or additionally, a seal can be applied to the apparatus or packaging of the apparatus that must be broken when the apparatus is unpacked or unfolded and thus indicates whether the apparatus has previously been used.

The control device is preferably configured such that the indicator device is activated depending on a detected maximum force exerted on the force transmission unit, a minimum force, a difference between the maximum and the minimum force, and/or the frequency of fluctuations in the detected force. In particular, the control device can be configured to continuously detect the compressive force exerted on the force transmission unit by receiving and processing a sensor signal from the force sensor continuously or with a brief cycle time. Maximum and minimum values of the exerted force can be determined based on the course over time of the sensor signal or the force value determined therefrom, with these values allowing compressions to be identified. For example, one can determine a relative maximum value and a relative minimum value within a full period of a periodic signal, with the frequency of these values corresponding to a preset frequency of the contractions to be exerted in cardiac massage. Based on this, a force amplitude can be determined based on the difference between the maximum and the minimum values, with said frequency being preset. However, the frequency of the compressions actually performed can also be determined based on the course over time of the sensor signal. In particular, the indicator device for generating a signal can be configured differently depending on the maximum detected force, the minimum force, the force amplitude, and/or the frequency of fluctuations in the force or the compressions, for example by generating sounds of different loudness and/or different pitch or optical signals of different brightness and/or colors; preferably, a plurality of signals that are of this type but perceptible via different sensory channels can be generated simultaneously. For this purpose, the indicator device can comprise a suitable sound generator and/or a suitable light source. For example, a suitable light source can be composed of a plurality of LEDs of different colors, such as red, green, and blue. This allows the user to obtain feedback during cardiac massage on the compressive force he/she exerts, the relaxation time between two compressions, and as to whether he/she is performing compressions with sufficient frequency.

It is also preferable for the control device to be configured such that the detected value of the compressive force exerted on the force transmission unit is compared with one or a plurality of predetermined target values and the indicator device is activated depending on conformity of the maximum force of a compression, the minimum force of a compression, the force amplitude, and/or the frequency of compressions with one or a plurality of target values or target ranges. Moreover, the control device can comprise first storage means in which preset target values and/or target ranges for the maximum force of a compression, the minimum force of a compression, the force amplitude, and/or the frequency of successive compressions are stored, with said values and/or ranges being accessible for conducting comparisons with the relevant values detected or determined based on the sensor signal. In particular, the control device can thus be configured such that based on the signal emitted by the indicator device, one can determine whether or not the compressions performed by a user are in conformity with target ranges for cardiac massage with respect to strength, amplitude, and/or frequency. In particular, the signal of the indicator device can be configured such that the direction of a deviation can be recognized based thereon so that a user can determine whether he/she should increase or decrease the maximum force, the amplitude of the compressions, and/or the frequency of the compressions in order to perform optimum cardiac massage. This can improve the safety of cardiac massage, even when performed by a medical lay person. Furthermore, because the preset target values and/or target ranges are stored, it is easy to adapt the apparatus according to the invention to conform to the prevailing requirements for different patient groups. For example, storage of corresponding target values makes it possible to optimize an apparatus according to the invention for the cardiopulmonary resuscitation of children or adults during production thereof without requiring any further modifications. By combining a plurality of apparatuses according to the invention having different sets of respective target values stored in their first storage means, it is therefore possible to provide a set of apparatuses for assisting users in cardiopulmonary resuscitation that is suitable for various uses.

It can further be provided that the control device is configured to emit a signal indicating the need for ventilation of the patient in addition to cardiac massage or alternating therewith. For example, it can be provided that a signal is generated after a preset time, after a preset number of compressions, or after a time depending on the amplitude of the compressions or the number of compressions that indicates the need for ventilation. In this way, the efficacy of cardiopulmonary resuscitation can be further improved.

The apparatus according to the invention is preferably equipped with an autonomous energy supply, particularly an electrical energy storage device, for example a battery or an accumulator. This makes it possible to ensure in a simple manner that the apparatus is immediately functional when needed, and in particular that the force sensor, the indicator device, and the control device are supplied with sufficient electrical energy.

According to a preferred embodiment of the invention, which is also claimed independently of the characterizing feature of claim 1, the control device comprises second storage means and is configured such that data are stored in the second storage means that indicate the detected values for the force exerted on the force transmission unit and/or its course over time; in other respects, the apparatus may be configured as described above. The second storage means can be configured with the first storage means as a single storage device. In particular, it can be advantageous to store the time elapsed from the first detected exertion of force after the apparatus is switched on or after the working mode begins, maximum values for the compressive force of the individual detected compressions, the force amplitude of the detected compressions, and the number and/or frequency of said compressions. Alternatively, it can be provided that the entire course of the sensor signal generated by the force sensor or the detected force values is stored. The stored data can be available for subsequent evaluation and can serve as a basis for decisions on further measures, for example with respect to further care following a successful resuscitation. The data can also make it possible to draw conclusions as to the effect of the cardiac massage performed, which for example can improve the learning effect of training in cardiopulmonary resuscitation with an apparatus according to the invention.

In a particularly advantageous configuration, the second storage means can be read via wire and/or wirelessly, so that the data stored therein are available for display, evaluation, and/or storage in a reading device. For example, the apparatus may comprise means for transmitting stored data by means of RFID technology, Bluetooth, or other wireless transmission paths. This makes it possible, for example, for medical personnel to immediately determine on arrival at the scene of an accident the type and effect of resuscitation measures carried out by a lay person, and based thereon, to take further measures, in particular relating to cardiac massage and/or ventilation.

Alternatively or additionally, at least some of the stored data may be representable on the indicator device. For example, the control device can be configured such that, in response to an input signal that can be input by means of a switch or in the event of an interruption in the force exerted on the force transmission unit, it activates the indicator device to generate a signal that makes important stored data identifiable. As an example, the number of repetitions of a brief acoustic or optical signal or the number of activated LEDs can indicate the number of minutes elapsed since the onset of working mode or a first detected exertion of force or the number of minutes during which fluctuating exertion of sufficiently strong force is detected by the force transmission unit. In this way, indications as to the resuscitation measures performed that can serve as a basis for decisions regarding further measures can be obtained in a particularly simple manner.

In a method according to the invention for assisting a user during cardiopulmonary resuscitation of a patient, the control device of an apparatus configured as described above can automatically be switched from sleep mode to working mode when the mat is unfolded, a compressive force exerted on the force transmission unit can be detected by the force sensor of the force transmission device, the indicator device of the apparatus can be activated by the control device based on the detected force, and data on the detected force and/or its course over time can be stored in a storage unit of the control device. For example, the stored data can be the time elapsed since a first exertion of force of a first compression, the maximum force of each compression, and/or the frequency of the detected compressions. According to advantageous improvements of the method according to the invention, the indicator device is activated depending on a maximum force exerted on the force transmission unit, a minimum force exerted on the force transmission unit, a difference between the maximum and the minimum force, and/or the frequency of fluctuation in the force exerted on the force transmission unit, depending in particular on conformity with a respective target value or target range. In a further advantageous configuration, it can be provided that the storage device of the control device is read in a wire-based or wireless manner.

In particular, for use of the apparatus according to the invention, said apparatus is first removed from a package, in which the apparatus may be shrink-wrapped. If the package has a seal, this destroys said seal, so that one can recognize that the apparatus has been used. In a following step, the apparatus is opened by unfolding the sections of the mat that are folded onto one another. This generates a sensor signal that causes the control device of the apparatus to be automatically switched from sleep mode to working mode. The optical and acoustic indicators can then be immediately activated as soon as working mode has been achieved, or it may be necessary to press a power switch for this purpose. The apparatus is placed on the chest of a patient and aligned by means of the markings printed on the upper side of the mat or provided by the shape of the mat. In this manner, one can ensure that a compression area marked on the upper side of the apparatus comes to rest over the area of the patient's chest on which the compressive force must be exerted in cardiac massage. The force transmission unit is embedded in the mat at the site where the corresponding area is marked on the upper side. As soon as the user exerts a compressive force on this area, this is detected by the force sensor of the force transmission unit, and the sensor signal is evaluated by the control device of the apparatus. If the preset target force for cardiac massage is not reached, this can be indicated by a corresponding sound or a colored optical signal, such as a red optical signal. If the exerted force is in the target range, this can be indicated by a green light. The force amplitude of a compression can also be measured and compared with a target range, and a corresponding signal can be transmitted to the user. Moreover, the target frequency of the compressions to be performed can be specified by a further light or sound, or the actual frequency of the exerted compressions can be measured, and this can generate a signal that makes it possible to determine whether the frequency is too low, within a target range, or too high. After a preset number of compressions, a signal can be generated that indicates that ventilation is needed. The cardiac massage is continued after this. Storage and reading of the detected force values, particularly the course over time of the exerted compressive force, can be advantageous in supporting a decision regarding the further care of the patient after use of the apparatus according to the invention is completed.

It is to be understood that the features mentioned above and to be explained below can be used not only in the respective combination given, but also in other combinations or alone, without departing from the scope of the present invention.

Further aspects of the invention are explained in the following description of two preferred embodiments and the attached drawing. The figures show the following:

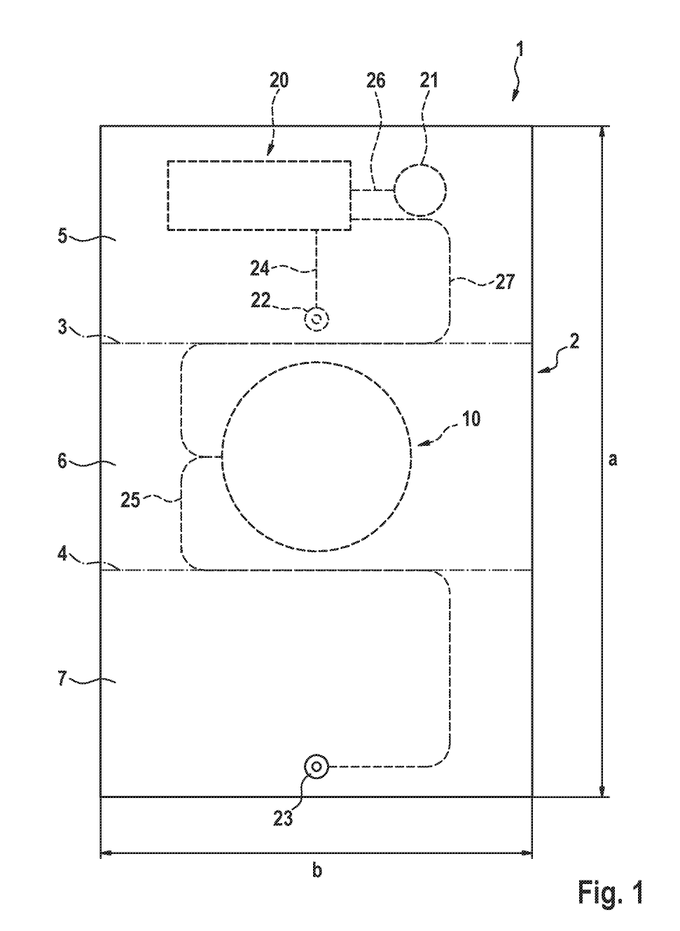

FIG. 1 is a top view of a first embodiment of an apparatus according to the invention in a unfolded state;

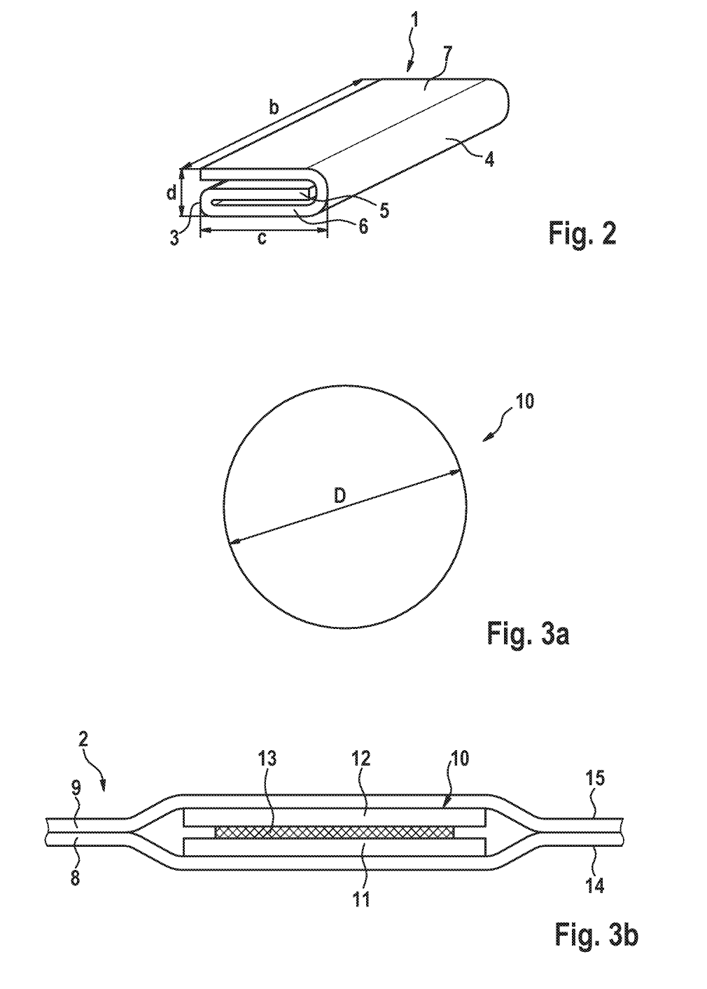

FIG. 2 is an oblique view of the apparatus according to FIG. 1 in a folded state;

FIGS. 3a and 3b show a top view and a sectional view of a force transmission unit of the apparatus according to FIG. 1;

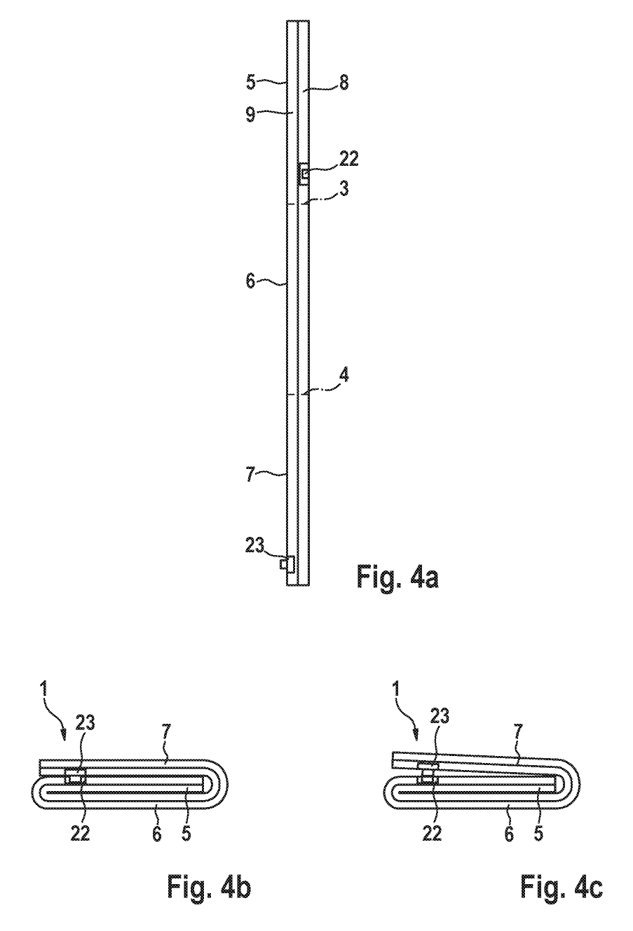

FIGS. 4a to 4c are simplified sectional views of the apparatus according to FIG. 1 in an unfolded, folded and partially unfolded state;

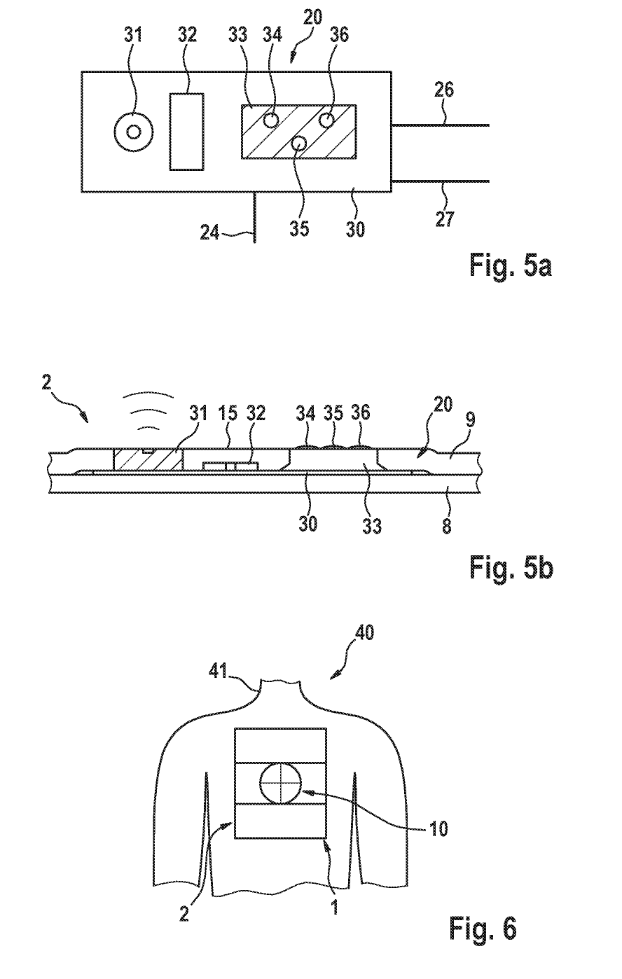

FIGS. 5a and 5b show a top view and a sectional view of an electronic unit of the apparatus according to FIG. 1;

FIG. 6 shows the apparatus according to FIG. 1 in a position of use;

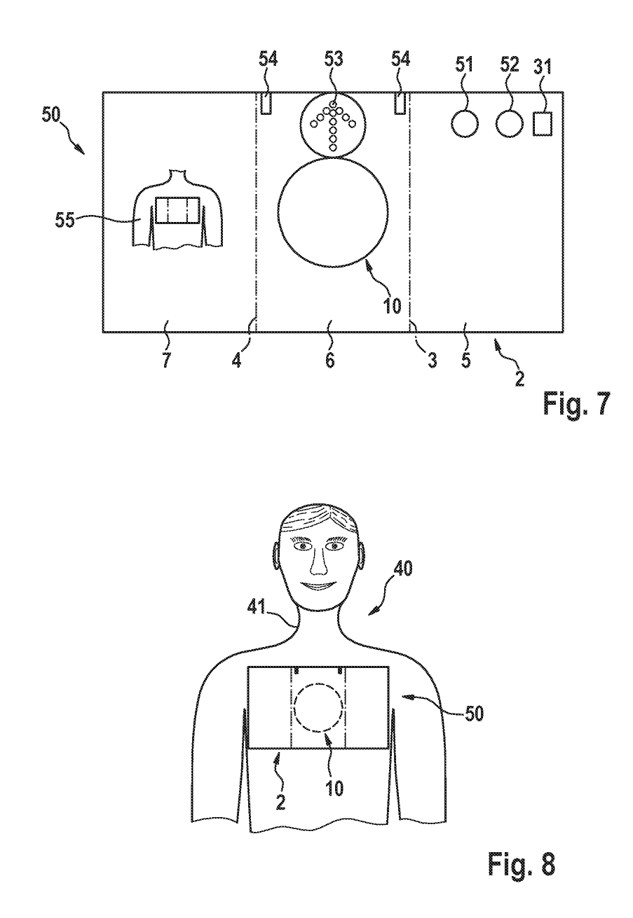

FIG. 7 shows a top view of a second embodiment of an apparatus according to the invention in an opened state;

FIG. 8 shows the apparatus according to FIG. 7 in a position of use.

As shown schematically in FIG. 1, an apparatus according to the invention for assisting a user during cardiopulmonary resuscitation according to an embodiment of the invention has an approximately rectangular shape overall, wherein the side lengths a, b are e.g. approx. 44 cm or approx. 24 cm. The apparatus 1 comprises a continuously flexible mat 2, which is subdivided into three sections 5, 6, 7 of approximately equal size by two fold lines 3, 4 running parallel to one another and parallel to the narrow sides of the rectangle. The mat 2 is sufficiently flexible overall to adapt itself to the surface of the chest of a patient on whom the apparatus 1 is placed. The fold lines 3, 4 are thinned out by stamping or milling, which provides them with greater flexibility compared to the sections 5, 6, 7. The apparatus 1 further comprises a force transmission unit 10 that is embedded in the mat 2 approximately in the center of the middle section 6 of said mat. Moreover, FIG. 1 shows an electronics unit 20 embedded in the mat 2 with a battery unit 21 and two mutually interacting snap fastener elements 22, 23 (see below). The battery unit 21 serves as the electrical energy supply of the electronics unit 20; for this purpose, for example, a button cell is placed in the battery unit 21 as an electrical energy storage device. FIG. 1 also shows electrical wires 24, 25, 26, 27 by means of which the snap fastener elements 22, 23, the battery unit 21, and the force transmission unit 10 are connected to the electronics unit 20. As can be seen in FIG. 1, the wires 25, 27 run through one or a plurality of fold lines 3, 4 and are correspondingly configured in a flexible manner. The wires 25, 27 can run in sections along the fold lines 3, 4 in order to improve the foldability of the mat 2.

The sections 5, 6, 7 can be placed on top of one another by folding them up along the fold lines 3, 4. In FIG. 2, the apparatus 1 is shown in a folded state. A first section 5 is folded at the fold line 2 over the second, middle section 6 of the mat 2 and rests on it. The third section 7 is folded along the fold line 4 over the sections 5, 6 that have been placed on top of one another. This gives rise to a highly compact apparatus whose side lengths are approximately b=24 cm, c=15 cm, and d=0.8 to 1.3 cm. The apparatus 1 thus fits in a folded state into a standard first aid kit according to DIN 13157. As shown in FIG. 1, the middle section 6 and the third section 7 have approximately equal side lengths, while the first section 5 is configured to be somewhat narrower in the direction of the long edge of the mat 2 so that it will come to rest within the folded up apparatus according to FIG. 2 without wrinkling.

The force transmission unit 10 is configured approximately in the form of a circular disk overall having a diameter D of approximately 5 to 12 cm (see FIG. 3a). As shown in a sectional view in FIG. 3b, the force transmission unit 10 is composed of a lower plate 11, an upper plate 12, and a force sensor 13 placed between them. The plates 11, 12 are both configured as flat circular disks that are arranged congruently to each other and are connected to each other via the force sensor 13, which also has a flat configuration. The plates 11, 12 may be composed of a hard plastic and have a thickness of approximately 0.3 to 1.4 mm respectively. In particular, the plates 11, 12 and the force sensor 13 can be flexible so that the force transmission unit 10 as a whole is flexible, and preferably elastically bendable, and has a stiffness that approximately corresponds e.g. to that of an ordinary credit card.

The force sensor 13, which for example can be a piezoelectric or a resistive force sensor, has e.g. a measuring range of 0.1 to 300 N and a thickness of approximately 0.1 to 2.5 mm, for example 0.45 mm. The force sensor 13 has e.g. a square surface with a side length of approx. 4 cm and has an accuracy of ±3%, an operating temperature range of −30 to +70° C., a response time of approx. 5 μs, and a useful life of approximately one million compression cycles, which is generally sufficient for the present application.

As can be further seen in FIG. 3b, the force transmission unit 10 is embedded in the mat 2. The mat 2 is composed of a lower layer 8 and an upper layer 9, which are connected to each other e.g. by gluing. The lower and the upper layer 8, 9 are composed for example of rubber or a suitable foam and each has a thickness of approx. 2 mm. The force sensor unit 10 is embedded between the lower layer 8 and the upper layer 9 and glued to the lower layer 8 and the upper layer 9. The electrical wire 27, via which the force sensor 13 is connected to the electronics unit 20 (see FIG. 1), and which is also embedded between the lower layer 8 and the upper layer 9 of the mat 2, is not shown in FIG. 3b. The underside 14 of the lower layer 8 has a slip-resistant coating or is roughened in order to allow secure and reliable positioning of the mat 2 on the patient's chest. The upper side 15 of the upper layer also has a slip-resistant coating or is roughened, is printable, and has brief instructions for use of the apparatus in cardiopulmonary resuscitation and markings for correct positioning printed on it.

In FIGS. 4a to 4c, the apparatus 1 is shown in an unfolded state, a folded state, and at the beginning of unfolding in a sectional view, with only the mat 2 and the snap fastener elements 22, 23 being shown. As shown in FIG. 4a, a first snap fastener element 22 that comprises a connector is arranged in the lower layer 8 of the mat 2 in the first section 5 adjacent to the fold line 3. A second snap fastener element 23 interacting with the first snap fastener element 22, which comprises a head that fits into the connector, is arranged in the upper layer 9 of the mat 2 in the third section 7 adjacent to the edge of the mat 2. When the apparatus 1 is in a folded state, the first section 5 is placed over the middle section 6 and the third section 7 is then folded over the first section 5. This brings the second snap fastener element 23 into contact with the first snap fastener element 22 such that the head snaps into the connector and the snap fastener elements 22, 23 are connected to each other. In the apparatus shown in FIG. 4b, the three sections 5, 6, 7 are folded over one another in the manner described, and the snap fastener is engaged with the snap fastener elements 22, 23. This provides a compact and easily portable apparatus (also see FIG. 2). Moreover, in the state in which the head of the second snap fastener element 23 engages with the connector of the first snap fastener element 22, a circuit is closed via the electrical wires 24, 25 by means of which the snap fastener elements 22, 23 are connected to the electronics unit 20 (see FIG. 1). As long as the circuit is closed, it can be assumed that the apparatus 1 is in the folded state shown in FIG. 4b, and is therefore not in use. In this state, the electronics unit 20 is in sleep mode, which consumes only an extremely low amount of energy and in which the circuit is controlled only by the snap fastener elements 22, 23. However, if the apparatus 1 is unfolded to bring it into operation, the head of the second snap fastener element 23 is pulled out of the connector of the first snap fastener element 22 and the circuit is opened; this is shown in FIG. 4c. Opening of the circuit is detected by the electronics unit 20, which is in sleep mode, and causes it to be switched to working mode, in which the further electrical and electronic functions of the apparatus 1 are activated.

In FIGS. 5a and 5b, the electronics unit 20 is shown in detail in a top view and in a section through the mat 2 in the first section 5. The electronics unit 20 comprises a printed circuit board (PCB) 30 that carries a sound generator 31, a microcontroller 32, and an LED unit 33. The sound generator 31 is for example a piezoelectric sound generator that is suitable for generating sounds in the audible frequency range at a volume high enough to be perceived even in a noisy environment. The LED unit 33 comprises a plurality of light-emitting diodes (LEDs) 34, 35, 36, which produce light of various colors at a brightness high enough to be perceived even in bright daylight, e.g. the LED 34 produces red light, the LED 35 green light, and the LED 36 blue light. The sound generator 31 and the LED unit 33 each have a thickness of approx. 2 to 3 mm. The microcontroller 32 is configured to receive and evaluate the sensor signal generated by the force sensor 13 and to control the sound generators 31 and the LEDs 34, 35, 36. For this purpose, the microcontroller 32 comprises processing means with corresponding drivers and a RAM storage unit in which the target values for the force of the compressions performed in cardiac massage and the frequency of said compressions are stored. The microcontroller 32 comprises a further storage unit in which are stored the measurement values for the force actually exerted, which is detected by the force sensor 13, together with corresponding time data provided by a clock or a pulse generator of the microcontroller 32, and thus the course over time of the cardiac massage. Moreover, the microcontroller 32 can also be equipped with transmission means for preferably wireless transmission of the stored data, e.g. by means of a Bluetooth, to a receiving device, which for example can be a smartphone having a corresponding app.

FIG. 5a also shows the electrical wires 24, 25 embedded in the mat 2 via which the circuit can be closed by the snap fastener elements 22, 23, the wire 26 via which the electronics unit 20 is supplied by the battery unit 21 with electrical energy, and the wire 27 via which the microcontroller activates the force sensor 13 of the force transmission unit 10 and receives the sensor signal therefrom (see FIG. 1).

As shown in FIG. 5b, the electronics unit 20 is inserted between the lower layer 8 and the upper layer 9 of the mat 2 and integrated into the upper layer 9 of the mat 2 such that the PCB 30 is embedded between the upper layer 9 and the lower layer 8 and the sound generator 31 and the LED unit 33 are flush with the upper surface 15 or extend slightly beyond it. The LED 30 can be glued to the upper layer 9 and the lower layer 8. The electrical wires 24, 25, 26, 27, which are not visible in FIG. 5b, are also embedded between the lower layer 8 and the upper layer 9 of the mat 2.

FIG. 6 is a symbolic representation of how the apparatus 1 is positioned in an opened state on the chest of a patient 40. Here, the area of the mat 2 in which the force transmission unit 10 is embedded comes to rest on the sternum so that compressions exerted on the force transmission unit 10 are transmitted to the sternum and cause compression of the chest. For this purpose, the area in which the force transmission unit 10 is embedded is indicated in color on the upper side of the mat 2. There are also markings present that facilitate the proper alignment of the apparatus 1, for example in relation to the neck 41 of the patient 40.

For use, the apparatus 1 is removed from a package in which it is sealed in a folded or closed state (see FIG. 2, FIG. 4b). The apparatus 1 is then unfolded or opened according to FIG. 4c, wherein the snap fastener elements 22, 23 are separated from each other and the circuit closed via said elements and the wires 24, 25 is opened. This places the microcontroller 32 in working mode, and the sound generator 31 and the blue LED 36 are activated in order to generate acoustic and optical signals in a rhythm corresponding to the target frequency of the compressions during cardiac massage; here, it can be provided that the signals are delayed, e.g. not emitted until approximately 2 seconds after the apparatus 1 is unfolded or opened. At the same time, an optical and an acoustic signal are preferably generated with a brief duration, e.g. approximately 50 ms respectively, and with a repetition frequency of approximately 100/min. The apparatus 1 is placed by a user on the chest of a patient 40 such that the force transmission unit 10, which is marked on the upper side 15 of the mat 2, comes to rest on the sternum in the area in which the compressive force must be exerted in cardiac massage; in this case, the shape of the mat 2 and optionally further markings on the mat 2 aid in correct positioning. The user then begins the cardiac massage, and for this purpose exerts a compressive force on the area marked on the upper side 15 of the mat 2. The compressive force exerted is continually monitored by the force sensor 13 of the force transmission unit 10, and after the end of each full period of the clock signal of approximately 100/min, the maximum and minimum compressive force detected within the period are determined. If the maximum value determined is above a first target value, for example 220 N, and the minimum value determined is below a second target value, for example 50 N, the green LED 35 is activated. If the maximum value is below the first target value and/or the minimum value is above the second target value, the red LED 34 is activated. After a preset number of compressions that fulfill the above conditions, an acoustic or optical signal is generated that indicates that ventilation is needed. After a preset time, a further signal is emitted, indicating that the cardiac massage should be continued. At the same time, the course over time of the exerted force or the compressions is stored in the RAM storage device of the microcontroller 32. In the event that medical personnel arrive after a lay person has performed resuscitation, the stored data are wirelessly read and displayed on a reading device such as a smartphone, and are then available as a basis for decisions with respect to other measures. After no further compressions have been performed for an extended period of time, the sound generator 31 and the LED unit 33 are no longer activated by the microcontroller 32, even after the snap fastener elements 22, 23 are again connected and separated. The microcontroller 32 is then available only for optionally reading the stored data again.

FIG. 7 is a schematic representation of a further embodiment of the present invention. In the apparatus 50 configured according to this embodiment, a white LED 51 is provided to indicate a preset pace of the compressions performed by a user during cardiac massage, and an LED unit 52 is provided to indicate whether or not the exerted force lies within a target range for cardiac massage. For this purpose, the LED unit 52 comprises a red and a green LED, wherein the green LED lights up when the exerted force is within the target range, and the red LED lights up when the force is too weak; a further LED can also be provided that is activated when the exerted force is too great, which only rarely occurs in practice, however. Moreover, a ventilation indicator is provided, for example in the form of an arrow 53 made up of blue LEDs, which is activated after a preset number of compressions in order to notify the user that ventilation of the patient is required. The mat 2 of the apparatus 50 is configured to be placed across the chest of a patient and has markings 54 in the middle section 6 for alignment in relation to the patient's neck. In other respects, the apparatus 50 shown in FIG. 7 is configured in a manner corresponding to the apparatus 1 described above and is used correspondingly.

As symbolically shown in FIG. 8, in the embodiment of FIG. 7, the correct position of the apparatus 50 or the mat 2 on the chest of a patient 40 is such that the neck 41 of the patient 40 is above the middle section 6. In order to facilitate corresponding positioning, the mat 2 has markings 54 that indicate the correct positioning of the mat 2 in relation to the neck 41 of the patient 40; there is also an imprint 55 on the upper side of the mat 2 that shows the correct positioning of the apparatus 50.

For purposes of clarity, not all of the reference symbols are shown in all of the figures. Reference symbols in a figure that are not explained have the same meaning as in the remaining figures.

### LIST OF REFERENCE SYMBOLS

1 Apparatus
2 Mat
3 Folding line
4 Folding line
5 Section
6 Section
7 Section
8 Layer
9 Layer
10 Force-transmission unit
11 Plate
12 Plate
13 Force sensor
14 Underside
15 Upper side
20 Electronics unit
21 Battery unit
22 Snap fastener element
23 Snap fastener element
24 Wire
25 Wire
26 Wire
27 Wire
30 PCB
31 Sound generator
32 Microcontroller
33 LED unit
34 LED
35 LED
36 LED
40 Patient
41 Neck
50 Apparatus
51 LED
52 LED unit
53 Arrow
54 Marking
55 Imprint
a Side length
b Side length
c Side length
d Height
D Diameter

1. Apparatus for assisting a user during cardiopulmonary resuscitation of a patient, comprising:
a force transmission unit with a lower plate that can be placed on a patient's chest;
an upper plate located at a distance from the lower plate;
a force sensor arranged between the lower plate and the upper plate for detecting a force that can be exerted on the patient's chest by means of the upper plate and the lower plate;
an indicator device for generating at least one signal that can be perceived by the user; and
an electronic control device for controlling the indicator device based on the force detected by the force sensor,
wherein the force transmission unit is embedded in a flexible mat.

2. Apparatus according to claim 1, wherein at least the lower plate is deformable.

3. Apparatus according to claim 1, wherein the mat comprises at least two layers between which the force transmission unit is embedded.

4. Apparatus according to claim 1, wherein the mat has a non-slip configuration on its underside and/or on its upper side and/or is printable or printed on its upper side.

5. Apparatus according to claim 1, wherein the mat is foldable.

6. Apparatus according to claim 5, wherein the mat comprises a plurality of sections, which are connected to one another via predetermined fold lines.

7. Apparatus according to claim 5, wherein the control apparatus has a sleep mode and a working mode and the apparatus comprises a sensor, wherein based on a signal from said sensor, the control device is switched from sleep mode to work mode on unfolding of the mat.

8. Apparatus according to claim 1, wherein the control device is configured such that the apparatus can only be used once.

9. Apparatus according to claim 8, wherein the control device is configured such that after a predetermined maximum duration of inactivity, which is determined after a final detection of an exerted force by the force sensor or a transition of the control device from sleep mode to working mode, said indicator device is permanently deactivated.

10. Apparatus according to claim 1, wherein the control device is configured to activate the indicator device depending on a maximum force exerted on the force transmission unit, a minimum force exerted on the force transmission unit, a difference between the maximum and the minimum force, and/or the frequency of fluctuations in the force exerted on the force transmission unit.

11. Apparatus according to claim 10, wherein the control device is configured to activate the indicator device based on a target value or a target range depending on conformity of the maximum force exerted on the force transmission unit, the minimum force exerted on the force transmission unit, the difference between the maximum and the minimum force, and/or the frequency of fluctuation in the force.

12. Apparatus according to claim 1, wherein the apparatus comprises an electrical energy storage device for supplying the control device and the indicator device.

13. Apparatus according to claim 1, wherein the control device comprises a storage device and is configured such that data are stored that represent the force detected by the force sensor and/or the course thereof over time.

14. Apparatus according to claim 11, wherein the storage device is readable by wire and/or wirelessly and/or at least some of the stored data can be represented by means of the indicator device.

15. A method for assisting a user during cardiopulmonary resuscitation of a patient, wherein the control device of an apparatus configured according to claim 1 is switched from sleep mode to working mode when the mat of the apparatus is unfolded, a force exerted on the force transmission unit of the apparatus is detected by the force sensor of the force transmission unit, the indicator device of the apparatus is activated by the control device based on the force detected, and data are stored by the control device that represent the force detected by the force sensor and/or the course thereof over time.
